(19) United States
(12) Patent Application Publication
(10) Pub. No.: US 2019/0161688 A1
(43) Pub. Date: May 30, 2019

(54) SOLID ADSORPTION PROCESS FOR REMOVING PARTICLES FROM HEAVY, PARTIALLY REFINED OILS

(71) Applicant: PHILLIPS 66 COMPANY, Houston, TX (US)

(72) Inventors: Zhenhua Mao, Bartlesville, OK (US); Bruce A. Newman, Bartlesville, OK (US); Ajoy P. Raje, Owasso, OK (US)

(73) Assignee: PHILLIPS 66 COMPANY, HOUSTON, TX (US)

(21) Appl. No.: 16/264,012

(22) Filed: Jan. 31, 2019

Related U.S. Application Data
(63) Continuation-in-part of application No. 14/969,006, filed on Dec. 15, 2015.
(60) Provisional application No. 62/093,576, filed on Dec. 18, 2014.
(60) Provisional application No. 62/093,668, filed on Dec. 18, 2014.
(60) Provisional application No. 62/093,690, filed on Dec. 18, 2014.
(60) Provisional application No. 62/093,708, filed on Dec. 18, 2014.
(60) Provisional application No. 62/093,722, filed on Dec. 18, 2014.
(60) Provisional application No. 62/093,797, filed on Dec. 18, 2014.
(60) Provisional application No. 62/093,832, filed on Dec. 18, 2014.

(51) Int. Cl. C10G 25/00; B01J 20/20

(52) U.S. Cl. CPC C10G 25/003; B01J 20/20; C10G 2300/1059; C10G 2300/1077; C10G 2300/205; C10G 2300/207; C10G 2300/1074; C10G 2300/202

(57) ABSTRACT

The invention relates to removing contaminants from hydrocarbon oil or carbon precursor oil using solid sorbents that are comprised primarily of carbon and preferably of coke particles. The coke particles have an affinity for contaminants in hydrocarbon oil and carbon precursor oil and are sized to be filtered from the liquid fuel without plugging. As the contaminants agglomerate onto the solid sorbent, the resulting particles form a filter cake on conventional filter materials in such a way as to allow the hydrocarbon oil or carbon precursor oil to pass on through without significant pressure drop or delay.

### CROSS-REFERENCE TO RELATED APPLICATIONS

This application is a continuation-in-part application which claims benefit under 35 USC § 120 to U.S. application Ser. No. 14/969,006 filed Dec. 15, 2015, entitled “A Mixture of Crude Oil and Solid Hydrocarbon Particles” which itself claimed the benefit under 35 USC § 119(e) to the following US Provisional applications: U.S. Provisional Application Ser. No. 62/093,576 filed Dec. 18, 2014, entitled “Sorbents for Removing Solid Particles from Crude Oil”, to U.S. Provisional Application Ser. No. 62/093,668 filed Dec. 18, 2014, entitled “A Mixture of Crude Oil and Solid Hydrocarbon Particles” to U.S. Provisional Application Ser. No. 62/093,690 filed Dec. 18, 2014, entitled “A Mixture of Crude Oil and Solid Hydrocarbon Particles”, to U.S. Provisional Application Ser. No. 62/093,708 filed Dec. 18, 2014, entitled “A System for Purifying Crude Oils”, to U.S. Provisional Application Ser. No. 62/093,722 filed Dec. 18, 2014, entitled “A System for Regenerating Adsorbents for Purifying Crude Oils”, to U.S. Provisional Application Ser. No. 62/093,797 filed Dec. 18, 2014, entitled “Upgrading Biofuel Crude Oils with Solid Sorbents for Petroleum Refinery Processing”, and to U.S. Provisional Application Ser. No. 62/093,832 filed Dec. 18, 2014, entitled “A Process for Purifying Petroleum Crude Oils”. All of the above provisional and non-provisional patent applications are incorporated herein by reference in their entireties.

### STATEMENT REGARDING FEDERALLY SPONSORED RESEARCH OR DEVELOPMENT

None.

### FIELD OF THE INVENTION

This invention relates to removing contaminants from hydrocarbons and particularly to removing contaminants from heavy fossil hydrocarbon precursors including petroleum refinery atmospheric residual oil, vacuum residual oil, heavy gas oil, slurry oil and coal tar.

### BACKGROUND OF THE INVENTION

Raw crude oil includes contaminants including inorganic and organic solid particles. These contaminants are, to varying degrees, undesirable in various products of refining and there has long been interest in removing such contaminants prior to refining and even in partially refined products. Such contaminants tend to concentrate in the heavier fractions in refining processes even after contaminant removing prior to any refining processes.

Heavy fossil hydrocarbon such as petroleum refinery residuals and coal tar are common precursors for making carbon materials. However, inorganic and organic solid particles adversely impact the quality and value of the resulting carbon material. Moreover, the contaminants are a primary cause of fouling in processing equipment. Fouling creates a thermally insulating layer in processing equipment impairing heat transfer and causing equipment shut down, lost productivity and more frequent refinery turn-arounds that are very costly.

Conventional filtering techniques for attempting remove such contaminants are unsatisfactory due to the substantial investment in filtering systems to provide filtering for the high liquid demand of a refinery that permit often recurring clogging and cleaning.

Some contaminants are removed through water desalting, but this is also a slow process that requires significant capacity for removing the water prior to refining process steps to meet liquid flow rates of full refineries and are not effective for many solid contaminants.

A low cost and effective technology is highly desired to provide low contaminant carbon precursor materials for making higher quality carbon products.

### BRIEF SUMMARY OF THE DISCLOSURE

The invention more particularly relates to a process for removing contaminants from heavy hydrocarbon oils where a solid sorbent is added to the hydrocarbon oil and the contaminants from the hydrocarbon oil are agglomerated or adsorbed to the solid sorbent, and then the solid sorbent with agglomerated/adsorbed contaminants is separated from the hydrocarbon oil.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic drawing of a first embodiment of process for removing contaminants from hydrocarbon oil;

FIG. 2 is a schematic drawing of a second embodiment of the process of separating contaminants of hydrocarbon oil;

FIG. 3 is a schematic drawing of a third embodiment of a process for separating contaminants of hydrocarbon oil including a system for activating the solid sorbent to have an affinity for certain contaminants; and

FIG. 4 is a schematic drawing of a fourth embodiment of a process for separating contaminants of hydrocarbon oil including a system for activating the solid sorbent to have an affinity for certain contaminants.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

In the present invention, it has been found that carbonaceous materials can be tailored to attach to contaminants in hydrocarbon oils such as heavy carbon precursor oils to create particles large enough to be easily filtered and separated therefrom. The primary contaminants that are desired to be removed are inorganic and organic solids including amines, mercaptans, metals and salts. Other contaminants that may need to be removed are compounds with heteroatoms such as nitrogen, sulfur, and oxygen. All of these are undesirable in carbon precursor oil. It has been found that anode and higher grade cokes, such as petroleum cokes, charcoal, wood char and similar carbonaceous materials may be prepared to attach to the undesired molecules for subsequent filter removal.

The carbonaceous materials are preferably heat treated to create the desired affinity for the target contaminants and then selected for a suitable size and surface area. For carbonaceous materials that are comprised of petroleum coke particles, it is preferred that such coke particles have not been calcined, sometimes called green coke particles. The green coke particles are selected to have an average particle size of at least 1 micron up to about 500 microns where an average size up to about 250 microns is generally more preferred and with particles being between 5 and 50 microns being somewhat more preferred. The coke may be heat treated, up to about 500° C. in nitrogen prior to use with carbon precursor oil.

The coke or carbonaceous particles are blended with the hydrocarbon oil for a sufficient time to attach themselves to the contaminants to form larger particles that are more amenable to separation from the fuel in a filter and then directed to a filter for solid separation. Once the filtrate is removed, the contaminated carbonaceous materials may be used as fuel to create process heat within a refinery or the carbonaceous particles may be reprocessed to remove or separate the contaminants from the carbonaceous particles such that the same particles may be used in a subsequent cycle or may be used as a fuel, such as an industrial fuel without reprocessing.

The green coke is mixed into the hydrocarbon oil and thoroughly dispersed to provide for substantial contact with contaminants as can be efficiently accomplished.

As shown in FIG. 1, the hydrocarbon oil is delivered directly to a mixing tank 12 from a supply line 15. The solid sorbent is added at delivery station 18 and the mixture of hydrocarbon oil and solid sorbent is blended by agitator 20. The mixture of hydrocarbon oil having the solid sorbent thoroughly dispersed therein is then separated by filter element 22 allowing the decontaminated hydrocarbon oil to pass through outlet 25 while wet solid sorbent with agglomerated contaminants thereon are allowed out through contaminant outlet 28.

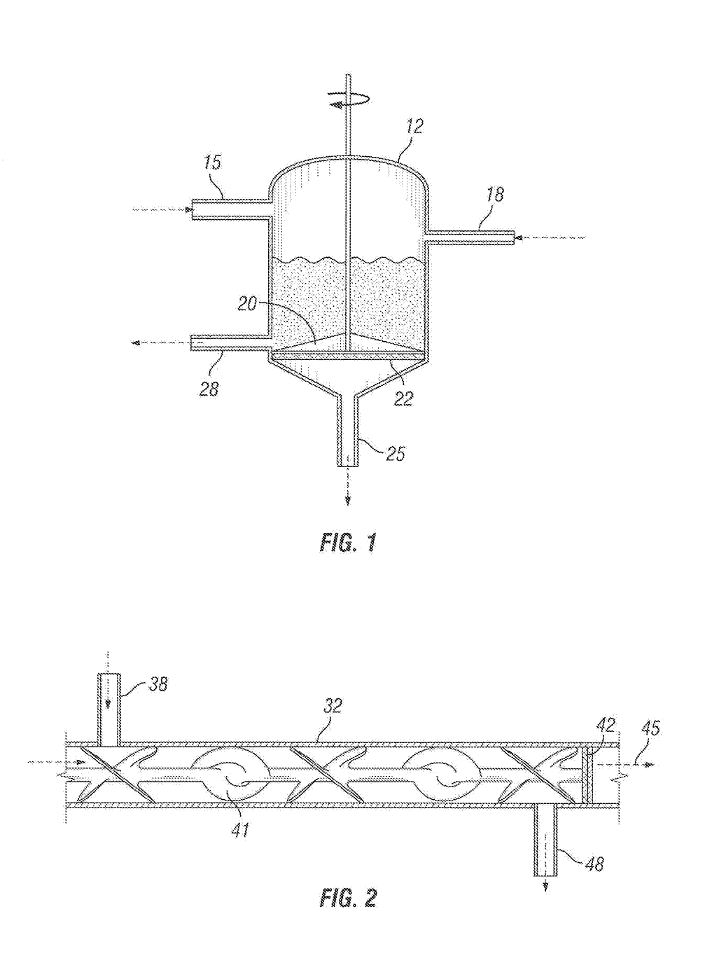

It should be understood that a number of embodiments for the inventive system may be defined such as shown in FIG. 2 where a section of pipe 32 for transporting hydrocarbon oil includes an inlet 38 for sorbent. The sorbent is blended and dispersed through the hydrocarbon oil via a static mixer 41. A filter element 42 is positioned at the end of the pipe section 32 defining a hydrocarbon oil outlet 45 and a contaminant outlet 48. The pipe section 32 may be horizontal, vertical with the flow going up or down or any other angle. The filter element 42 may be perpendicular to the flow of the hydrocarbon oil through the pipe section 32, perpendicular to the pipe section 32 (such as in the side walls) or any other practical orientation in the pipe section 32. Similarly, the contaminant outlet may also be arranged at an angle to the pipe section or straight out the end.

The hydrocarbon oil mixture comprises between 95% and 99.9% hydrocarbon oil and between 0.05% and 5% green petroleum coke solid sorbent. In one preferred arrangement, the green petroleum coke solid sorbent has an average size between about 2 microns and about 50 microns although sizes between about 5 microns and about 15 are especially preferred. The mass ratio of hydrocarbon oil to sorbent may be maintained at a ratio of at least 1 kg sorbent to 500 kg of hydrocarbon oil. More preferably, the hydrocarbon oil would include a higher ratio of sorbent such that at least 5 kg of sorbent would be thoroughly mixed with 500 kg of hydrocarbon oil such that the ratio is 100:1. The ratio may include up to 1 kg of sorbent to 2 kg of hydrocarbon oil when the hydrocarbon oil is heavily laden with contaminants, but as a practical matter, it is more likely that the ratio will be between 100:1 and 10:1. The composition may be maintained at a temperature that is elevated above average room temperature but less than 400° C.

The density of the sorbent is preferably between 0.5 g/cc and 7 g/cc and more preferably between 0.7 g/cc and 2.0 g/cc. The sorbent particles are partially or almost totally hydrocarbon materials that contain a residual carbon content of at least 40%, preferably between 75% and 99%, more preferably between 85% and 98%. The residual carbon content is defined by ASTM D7662-13.

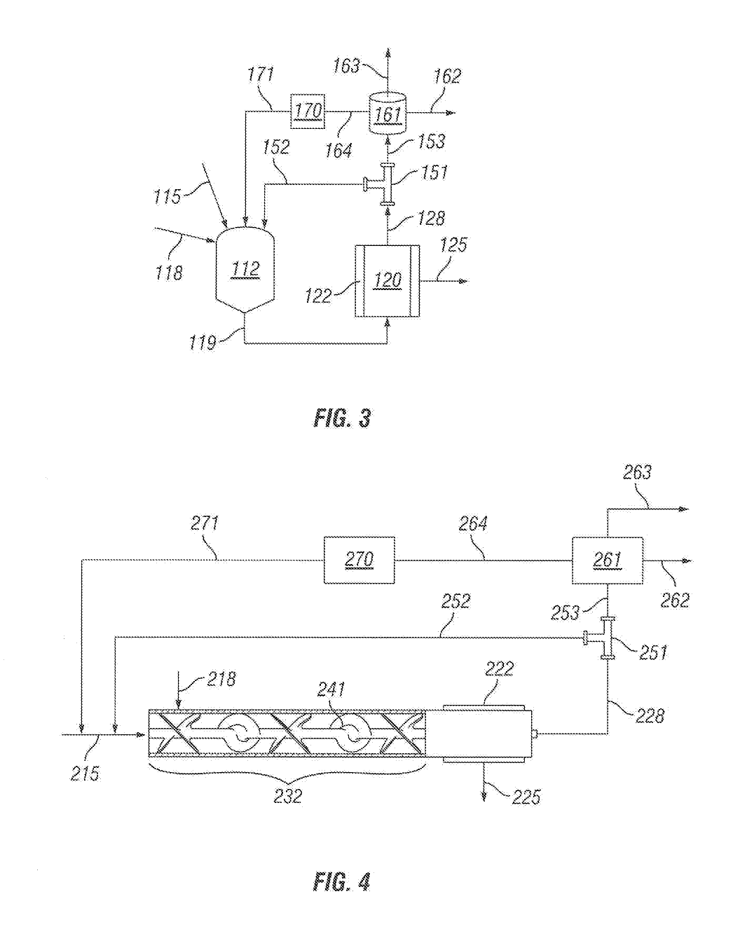

The wet green coke with the agglomerated/adsorbed contaminants may be processed for re-use. As shown in FIG. 3, a mixing tank 112 is provided for mixing carbon precursor oil and solid adsorbent. Carbon precursor oil is supplied at inlet 115 and fresh adsorbent is supplied at inlet 118. After mixing using a suitable mixing technology, the mixture is conveyed via line 119 to separation device 120 including filter media 122. While one separation device 120 is shown, it should be understood that multiple such devices may be included where some are in use having a filter cake formed on the media 122 while other separation devices 120 are offline having the filter cake flushed or back-flushed for further treatment. The cleaned hydrocarbon oil is removed through outlet 125 and carried on for further processing in the refinery or isolated for transport or sale and the contaminant laden adsorbent exits via line 128. The sorbent is subjected to further separation at sorbent separator 151. Some solid sorbent 152 is returned to the mixing tank 112 while remaining sorbent with hydrocarbon oil is delivered to regenerator 161 via line 153. While the amount of hydrocarbon oil with the sorbent in sorbent regenerator 161 is small compared to the hydrocarbon oil recovered at outlet 125, clean hydrocarbon oil is discharged through outlet 162 and isolated for shipment and sale or directed for further processing the refinery. The re-generation process includes recovery of liquid oil and thermal treatment of the solid material to liberate or pyrolize the contaminants. The wet sorbent after adsorption first goes through evaporation to recover the hydrocarbon oil at an elevated temperature either under reduced atmosphere pressure or at ambient pressure. The dried solid powder is subjected to the specific thermal treatment either under reduced atmosphere pressure or at a pressure less than 15 psi. The sorbent is subjected to regenerating temperatures that are at least 100° C., preferably between 100° C. and 1000° C., more preferably between 200° C. and 750° C., even more preferably between 250° C. and 550° C. The atmosphere for the thermal treatment is preferably inert; nitrogen gas and other hydrocarbon gas are preferred.

Regenerated green coke sorbent is delivered to the mixing tank 112 via line 164 and 171. It is noted that a device 170 is shown for providing an alternative treatment for the sorbent as will be described below. The regenerated coke sorbent attains substantial amounts of its sorbent functionality through regeneration, but the step typically includes some selection by sizing eliminating sorbent particles that have attritted down to an unacceptable size and eliminated from the process through discharge 163. Using recycled sorbent is a low cost way to reuse sorbent that provides some level of sorbent function, but especially helps by increasing the available surface area within the crude mixing tank so as to create many contact opportunities by the sorbent and the contaminants.

The process may further be accomplished with a system having a different appearance, but having similar operations as shown in FIG. 4 where the hydrocarbon oil enters a mixing area 232 via inlet 215. Fresh green coke sorbent is delivered via inlet 218. The sorbent and hydrocarbon oil are mixed together by a mixer 241, such as a static mixing element as shown. The cleaned or decontaminated crude exits through outlet 225 after passing through filter media 222. The hydrocarbon oil laden sorbent is carried on through line 228 for further separation at sorbent separator 251. Some solid sorbent 252 is returned to the mixing zone 232 while remaining sorbent with hydrocarbon oil is delivered to regenerator 261 via line 253. While the amount of hydrocarbon oil with the sorbent in sorbent regenerator 261 is small compared to the hydrocarbon oil recovered at outlet 225, clean hydrocarbon oil is discharged through outlet 262 and isolated for shipment and sale or directed for further processing the refinery. The re-generation process includes recovery of hydrocarbon oil and thermal treatment of the solid material. The wet sorbent after adsorption first goes through evaporation to recover the liquid oil at an elevated temperature either under reduced atmosphere pressure or at ambient pressure. Regenerated green coke sorbent is delivered to the mixing zone 232 via line 264 and 271. Device 270 provides an optional treatment for the sorbent as described below. The regenerated coke sorbent attains substantial amounts of its sorbent functionality through regeneration, but the step typically includes some selection by sizing eliminating sorbent particles that have attritted down to an unacceptable size and eliminated from the process through discharge 263.

Some crude oils contain corrosive compounds such as various nitrogen-containing compounds that may end up in the hydrocarbon oil. With the solid adsorption process, these soluble basic species may also be effectively removed from hydrocarbon oil by including an acidifying treatment to the green coke sorbent. This acidifying treatment may be applied in device 170 or 270 as shown in FIGS. 3 and 4. For the applications where basic species need to be removed, the atmosphere is preferably oxidative; oxygen gas and other oxidative gases such as various acids and peroxides are also introduced into the atmosphere so that carbonaceous species on the sorbent surface are oxidized to form acidic groups. These acidic groups on the sorbent surface provide the functionality of absorbing basic species. The acidifying regenerating step would be performed in the regenerator 161.

With a blend of fresh green coke and acidified green coke particles, the same materials being adsorbed/agglomerated as first described are still being adsorbed and agglomerated, but there are now sorbent particles that also adsorb the undesirable basic or alkaline molecules.

The process is particularly applicable to removing cyclic or ring compounds, aromatics and polar compounds from hydrocarbon oil. The solid sorbents are dispersed in the hydrocarbon oil such that solid sorbent particles and hydrocarbon oil has sufficient contact, resulting in full adsorption of the solid particles (ultrafine and micron sized organic and inorganic solid material) in the hydrocarbon oil. The resulting solid sorbent and liquid hydrocarbon oil is separated continuously or semi-continuously through filtration. The details are described below.

Referring to FIG. 1, the process according to this invention includes two simultaneous major steps: (a) mixing solid sorbent with crude oil and (b) separating impurity solid and salt particle-loaded sorbent particles from liquid oil. The special sorbent materials according to this invention enable such operation to be effective and economically viable.

Even though conventional solid sorbents such as activated carbon or filtration aid agent such as silicate and Celite® may be used as the sorbent for this purpose, green coke particles are preferred because those conventional sorbents are relatively expensive and may not have the affinity with certain contaminant hydrocarbons compared with particulate green coke materials. The so called “green coke” materials herein are petroleum cokes or charred coal tars before calcination (>1000° C.) that contain a certain amount of volatile content. Preferably the green coke has carbon content between 25% and 99.0%, more preferably between 75% and 98%. The amount of volatile content in a green coke may reflect the mechanic strength of green coke particles and the affinity of such coke surface with crude oil; a too high volatile content may lead to too weak mechanic strength of green coke particles, which may cause breaking-up of particles on collision of particles. A too high carbon content (e.g. >99.5%) may yield a low affinity with crude oils, which may have a low adsorption ability for large and polar molecules that are preferably removed from crude oil.

It should be pointed out here that the above sorbent or green coke materials may also contain significant amount of inorganic solids, the carbon content aforementioned is the hydrocarbon portion in the sorbent.

The size of green coke particles is important factor in determining adsorption rate and maximum loading of adsorbed solid particles. The smaller the particle size the larger the surface area and the faster for adsorption. However, the smaller particle size also may lead to the denser filtration cake layer on the filtration screen, resulting in a slower liquid flow rate. To achieve a fast adsorption rate and a good liquid flow through the filtration screen, the average green coke particle size is preferably between 3 and 500 μm, more preferably between 5 and 50 μm.

### EXAMPLES

### Example 1

This Embodiment Illustrates that Removing Solid Particles from Slurry Oils Alleviates the Fouling Propensity During the Thermal Processing or Coking:

Two slurry oils from two refineries were selected and two green coke powders were used. Both the slurry oils have a standard boiling point of 650+° F. but came from significantly different crude oils, the first one from a light crude oil and the other one from a heavy crude oil. The first green coke has a volatile content of about 12% and the second one contains 7% volatile content, and the average particle size of both powders was about 8-micron meters. 250 grams of slurry oil and 5 grams of the green coke powder were mixed at 110° C. and then poured in a filter pressure vessel. The liquid was filtered through a sintered metal disk (0.5 μm pore size and 4 in² total area) The resulting solid cakes were washed fully with toluene and dried under vacuum at 100° C. for at least 15 hours. The weight of the dried solid cake was used to determine the amount of the impurity solid in the slurry oil. Both the slurry oils before and after filtration were analyzed for their metal composition by the ICP-AES technique.

Table 1 summarizes the total solid removed and the elemental contents in the slurry oils before and after solid adsorption and filtration. The solid adsorption with the green coke powder removed 750 ppm of the impurity solid from the first slurry oil and about 400 ppm from the second oil. The removed elemental content depends on the slurry; the solid adsorption removed nearly completely the elements such as Al, Cu, and Na and 98% of Ca was removed from the second slurry and 67% of it from the first slurry oil. Similarly, Fe was completely removed from the second slurry oil compared with 90% from the first. Ni and V are known to exist as metal porphyrins and are stable in slurry oil. However, the solid adsorption still removed one third of these elements. The remaining elements in the slurry oil after the adsorption are mainly Ni and V, particularly with the second oil. It is expected that such effective removal of unstable solid particles would alleviate the fouling propensity.

TABLE 1

| | | Slurry Oil: | | | | |
|---|---|---|---|---|---|---|
| | | Slurry Oil 1 | | Slurry Oil 2 | | |
| | | Sorbent: | | | | |
| | | none | A | none | A | B |
| Solid Removed (ppm) | | 752 | | | 397 | 444 |
| Metal Element | Al | 2.51 | <1.00 | 6.38 | <1.01 | <1.01 |
| in Slurry Oil | Ca | 16.8 | 5.51 | 22.4 | 0.47 | 0.52 |
| (ppm) | Cu | Not detectable | | 9.18 | <1.11 | <1.11 |
| | Fe | 72.3 | 7.49 | 40 | <3.12 | <3.12 |
| | Mg | 3.03 | <1.30 | 1.62 | <1.31 | <1.31 |
| | Mo | Not detectable | | 21.9 | 14.7 | 13.4 |
| | Na | 63.8 | <7.40 | 9.63 | <7.44 | <7.44 |
| | Ni | 5.07 | 3.54 | 163 | 109 | 98.8 |
| | Sr | 1.19 | <0.300 | Not detectable | | |
| | Ti | Not detectable | | 4.29 | 2.5 | 2.26 |
| | V | 10.6 | 7.64 | 405 | 278 | 251 |
| | Zn | 0.89 | <0.40 | 4.14 | 0.46 | <.040 |

### Example 2

This example demonstrates that the solid adsorption can also remove the impurity solid particles from very heavy refinery residuals. Four vacuum resids were selected from different sources; each of the resids had a boiling point of 940+° F. and is solid at ambient temperature. Limited by the maximum temperature of the experimental apparatus (125° C.), those resids were diluted with toluene in 1:1 mass ratio. The resulting mixtures were processed in the same way as Example 1 with the mass ratio of 50 to 1 (mixture to sorbent). The same green coke powder as sorbent B in Example 1 was used. After solid adsorption, toluene was evaporated from the liquids. The resulting liquids were processed under the standard coking condition (900° F. at 60 psi for eight hours) to form cokes. The solid cokes were removed from the coking tube and calcined in nitrogen gas at 1350° C.

The amount of the solid particles and the remaining metal element content in the resids before and after the solid adsorption are listed in Table 2. The resids A and D had a low removable solid content as they exist as porphyrin Ni and V, for the other elements such as Ca and Fe, the removable content depends on the resid property; for resid C, Fe can be effectively removed, while for the other resids, Fe were partially removed. Na is known for not chelating with organic compounds, thus, it is effectively removed by the solid adsorption. As expected, there is only a small improvement in the CTE value with the solid adsorption because of the low inorganic solid content in these resids. However, it is expected that the other critical physical properties of the resulting coke such as CO₂ and air reactivity are significantly improved because of the low metal content.

TABLE 2

| | | Residual Oil | | | | | | | |
|---|---|---|---|---|---|---|---|---|---|
| | | Resid A | | Resid B | | Resid C | | Resid D | |
| Solid Removed | | | 166 | | 438 | | 481 | | 133 |
| (ppm) | | | | | | | | | |
| Metal Element | Al | 7.44 | <1.06 | 10.1 | <1.02 | 4.98 | 1.15 | 9.06 | 1.73 |
| Content in Resid | Ca | 14.6 | 1.39 | 55.6 | 16.8 | 18 | 1.58 | 21.6 | 4.73 |
| (ppm) | Fe | 5.6 | 3.49 | 14 | 9.98 | 43.3 | <3.11 | 18.9 | 3.63 |
| | Mg | 1.53 | <1.28 | 6.79 | 5.07 | 1.81 | <1.30 | 5.28 | <1.31 |
| | Mo | 7.01 | 6.75 | 8.49 | 8.37 | | | | |
| | Na | | | 33.4 | <7.56 | 28.2 | <7.42 | 18.9 | <7.47 |
| | Ni | 108 | 105 | 105 | 106 | 116 | 103 | 111 | 84.2 |
| | Ti | 5.8 | 5.63 | 6.54 | 6.16 | | | | |
| | V | 234 | 229 | 212 | 213 | 254 | 229 | 246 | 223 |
| | Zn | 0.51 | <0.40 | 0.78 | 0.55 | 0.74 | 0.52 | 0.76 | 0.60 |

### Example 3

This example illustrates that addition of the desirable solid sorbent in slurry oil enhances the filtration rate of the slurry oil. In this example, a slurry oil with a high impurity solid content was selected. The slurry oil has a boiling point of 640+° F. 300 grams of the slurry oil were mixed with different amount of the green coke powders that were used in Example 1 and heated to about 110° C. Subsequently, the mixture poured into the same filter vessel and filtered through the 4 in² disk. The times required for passing 100, 200, 250 cc, and all the slurry oil through the filter were recorded to compare the flow rates. Similar to the above examples, the solid cakes were washed thoroughly with toluene and dried to determine the amount of the impurity solid particles.

As shown in Table 3, this slurry oil contained about 1300 ppm removable/filterable solid particles. As the content of the green coke sorbent was increased from 0.1% to 1% (by weight of the slurry oil), the time for passing a certain amount of the slurry oil through the filter decreased significantly, for example, from 32 minutes to 13.3 minutes for passing 250 ml with the sorbent B. Even with as little as 0.1% of the sorbent (which is less than the total filterable solid content in the slurry oil), the time was reduced by one third from ˜30 minutes to 20 minutes. It was observed that the filtration cake was loosely packed in the presence of the green coke sorbent whereas it was fairly densely packed without any sorbent.

TABLE 3

| Total 300 Grams | | | | | | | |
|---|---|---|---|---|---|---|---|
| of Slurry Oil | | | | | | | |
| | | Filtration | Filtration time (minutes) | | | | Solid |
| Coke | Sorbent | Temp | 100 | | | | removed |
| Type | (ppm) | (° C.) | ml | 200 ml | 250 ml | Total | (ppm) |
| A | 0 | 119 | 22.5 | 28.8 | 30.3 | 33.8 | 1382 |
| | 1000 | 107 | 11.2 | 17.1 | 19.1 | 20.5 | 1327 |
| | 5000 | 115 | 11.5 | 15.4 | 16.5 | 17.5 | 1309 |
| | 10000 | 115 | 15.6 | 19.2 | 20.4 | 22.1 | 1281 |
| B | 1000 | 108 | 19.2 | 28.4 | 32.5 | | 1297 |
| | 5000 | 115 | 14.4 | 18.0 | 19.3 | 21.2 | 1199 |
| | 10000 | 102 | 7.2 | 11.4 | 13.3 | 14.2 | 1416 |

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for removing contaminants from carbon precursor oil comprising:
a) adding a solid sorbent to the carbon precursor oil;
b) agglomerating/adsorbing contaminants from the carbon precursor oil to the solid sorbent; and
c) separating the solid sorbent with agglomerated/adsorbed contaminants from the carbon precursor oil.

2. The process according to claim 1 wherein the solid sorbent is green coke.

3. The process according to claim 2 wherein the green coke has an average size of between 1 and 250 microns.

4. The process according to claim 2 wherein the green coke has an average size of between 3 and 50 microns.

5. The process according to claim 2 wherein the green coke has an average size of between 3 and 25 microns.

6. The process according to claim 1 wherein the solid sorbent is a mixture of green coke and recycled green coke that has been subjected to an inert heating process to liberate contaminants from a previous contaminant adsorption process.

7. The process according to claim 6 wherein the mixture of green coke and recycled green coke has an average particle size of between 1 and 250 microns.

8. The process according to claim 6 wherein the mixture of green coke and recycled green coke has an average size of between 3 and 50 microns.

9. The process according to claim 6 wherein the mixture of green coke and recycled green coke has an average size of between 3 and 25 microns.

10. The process according to claim 1 further including a step of de-wetting the solid sorbent with containments agglomerated thereon so as to remove any residual carbon precursor oil from the solid sorbent.

11. The process according to claim 10 further including the step of heating the solid sorbent to liberate the contaminants from the solid sorbent and to prepare the solid sorbent for recycling for re-use as solid sorbent in the contaminant removal process.

12. The process according to claim 11 further including the step of separating undersized solid sorbent particles prior to recycling the solid sorbent so as to maintain a desired particle size for the solid sorbent used in the contaminant removal process.

13. The process according to claim 1 wherein the solid sorbent is subjected to a heat treatment step of up to 500° C. in a nitrogen environment prior to the step of adding solid sorbent to the carbon precursor oil.
